(19) United States
(12) Patent Application Publication
(10) Pub. No.: US 2015/0012323 A1
(43) Pub. Date: Jan. 8, 2015

(54) GENERATING MULTIPLE OPTIMAL DAILY SCHEDULES FOR MULTIPLE TIME PERIODS IN A DAY AND FOR MULTIPLE DAILY PATTERNS

(71) Applicant: ORACLE INTERNATIONAL CORPORATION, Redwood Shores, CA (US)

(72) Inventors: Nabil Guerinik, Boulogne-Billancourt (FR); Malika Guerinik, Boulogne-Billancourt (FR); Guillaume Beuchard, Nantes (FR)

(21) Appl. No.: 13/934,177

(22) Filed: Jul. 2, 2013

(51) Int. Cl. G06Q 10/10

(52) U.S. Cl. CPC G06Q 10/1097
USPC 705/7.21

(57) ABSTRACT

A computer and method use at least an index of a last item in a new partial schedule and an ending time of the last item to identify a set of one or more stored partial schedules. The computer and method determine whether the new partial schedule dominates any stored partial schedule in the set, based on comparison of at least new lower bound(s) and new upper bound(s) on attribute(s) of a complete schedule that comprises the new partial schedule, with corresponding lower bound and upper bound of each complete schedule to be built using each stored partial schedule. Any stored partial schedule in the set is removed, when the new partial schedule is determined to dominate said any stored partial schedule. When no stored partial schedule in the set dominates the new partial schedule, the new partial schedule is added to the set, followed by repeating the process.

### CROSS REFERENCE TO RELATED APPLICATIONS

This application is related to U.S. application Ser. No. 13/934,148, entitled “GENERATING COST OPTIMIZED SEQUENCES OF ACTIVITIES, FOR MULTIPLE VALUES OF A SEQUENCE ATTRIBUTE, FOR NUMEROUS TIME PERIODS OF A DAY” filed concurrently herewith, by Nabil Guerinik et al. which is incorporated by reference herein in its entirety.

This application is also related to U.S. application Ser. No. 13/804,529 entitled “MODELING A GAP BETWEEN WORKLOAD AND NUMBER OF EMPLOYEES TO BE SCHEDULED BY CREATING AND USING NEW WORKLOAD LEVELS” filed on Mar. 14, 2013 by Nabil Guerinik et al. which is incorporated by reference herein in its entirety.

### BACKGROUND

It is common in today's businesses to automatically prepare schedules for employees to perform various activities to accomplish the work to be done in the businesses, as described in, for example, U.S. Pat. No. 6,823,315 entitled “Dynamic Workforce Scheduler” granted to Bucci et al. which is incorporated by reference herein in its entirety as background. U.S. Pat. No. 6,823,315 appears to describe a method of dynamically scheduling a workforce, which includes obtaining employee preferences, determining a workforce schedule, determining a schedule value, iteratively modifying the workforce schedule, determining a schedule value for the modified workforce schedule, and comparing schedule values to determine a best workforce schedule.

U.S. Pat. No. 7,725,339 entitled “Contact Center Scheduling Using Integer Programming” granted to Aykin is incorporated by reference herein in its entirety as background. This patent appears to describe a method for formulating a Mixed Integer Linear Programming (MILP) model, and a solution algorithm for developing optimal schedules. More specifically, U.S. Pat. No. 7,725,339 appears to describe obtaining a solution to satisfy constraints of a MILP model with a minimization (maximization) type objective function, such as total cost.

U.S. Pat. No. 6,278,978 entitled “Agent Scheduling System And Method Having Improved Post-Processing Step” granted to Andre et al. is incorporated by reference herein in its entirety as background. U.S. Pat. No. 6,278,978 appears to state that evaluation of a score function for a possible schedule includes selecting, for each interval in the possible schedule, one of multiple predetermined values corresponding to distinct staffing levels. U.S. Pat. No. 6,278,978 appears to use a post-processing procedure for optimizing a schedule. However, use of a post-processing procedure can have drawbacks, e.g. a large number of iterations may be needed to obtain a locally optimal schedule. When a maximum number of iterations is reached, the post-processing must be terminated, etc. Hence, there is a need for an improvement of the type described below.

### SUMMARY

In several aspects of described embodiments, a method and one or more computer(s) automatically retrieve from one or more computer memories, a new partial schedule to be included in a complete schedule for an employee in an organization. The one or more computers use at least a last item assigned in the new partial schedule and an ending time of the last item to identify and retrieve from the one or more computer memories, a set of one or more stored partial schedules. Each partial schedule includes a sequence of slots of time (“time slots”) in a day to which have been assigned a number of items, each item assigned in the sequence being of type work or break. An item of type work assigned in the sequence identifies one or more time slots that are scheduled for activities of work to be done by an employee in the organization. An item of type break assigned in the sequence identifies one or more time slots in which no work is to be done (e.g. time to eat lunch).

The computer(s) and method determine whether the new partial schedule dominates a stored partial schedule in the set or vice versa, e.g. based on comparison of at least: (A) lower and upper bounds on attribute(s) of a first complete schedule to be built to include the new partial schedule, with (B) lower and upper bounds on attribute(s) of a second complete schedule to be built using the stored partial schedule. Two examples of attributes are (1) total hours in which an employee must work in a day (also called work duration), and (2) an ending time at which the employee is scheduled to leave the premises of the organization (also called ending time of shift, or ending time of work day). In addition to comparing attribute bounds, such a computer and method may compare costs of the new and stored partial schedules, to determine dominance there-between.

A stored partial schedule in a set may be removed from the set and discarded, when the new partial schedule is determined to dominate the stored partial schedule. The new partial schedule is discarded when the new partial schedule is determined to be dominated by any stored partial schedule in the set. When all stored partial schedules have been compared with the new partial schedule, and no stored partial schedule in the set dominates the new partial schedule, the new partial schedule is added to the set. Although only one condition has just been described for storage and removal of partial schedules in some embodiments, other embodiments may test additional conditions, based on, e.g. costs of schedules. The just-described process may be repeated, after generating another new partial schedule, based on a pattern of items, until all items in the pattern are used. Thereafter, the above-described process may be repeated for other times in a day and/or for other patterns, and for other employees in the organization.

Removal of one or more stored partial schedules in the set which are found to satisfy one or more conditions relative to a new partial schedule reduces memory and computation. For example, removal of stored partial schedules that are dominated by (and more costly than) the new partial schedule eliminates memory otherwise required if these stored partial schedule(s) continued to be stored. Also, not adding to the set, a new partial schedule determined to be dominated by (and more costly than) any stored partial schedule, reduces memory otherwise needed to store the new partial schedule. Moreover, removing a stored partial schedule also eliminates computation otherwise required in comparing the set of stored partial schedules with to-be-created schedules and/or in using the stored partial schedules in the set to generate additional schedules (partial or complete).

It is to be understood that several other aspects and embodiments will become readily apparent to those skilled in the art from the description herein, wherein it is shown and described various aspects by way of illustration. The drawings and detailed description below are to be regarded as illustrative in nature and not as restrictive.

### BRIEF DESCRIPTION OF THE DRAWINGS

FIG. 1 illustrates, in a high-level block diagram, a day schedule generator 110 of several embodiments that automatically maintains in a matrix 150IJ in memory 1106, partial schedules for an employee I in an organization, for multiple patterns and for multiple periods of time in a day J.

FIGS. 2A and 2B illustrate, in intermediate-level flow charts, acts performed by a computer 1000 in several embodiments, to prepare partial schedules of the type illustrated in FIG. 3B.

FIG. 3A illustrates a pattern 300 for a day J, as a sequence of items (namely work item 301, lunch break item 302, work item 303) used as input in some of the embodiments illustrated in FIGS. 2A and 2B.

FIG. 3B illustrates another pattern P1 used by computer 1000 to prepare a first partial schedule PS1 and a second partial schedule 152R both ending at 2 pm that may be completed into two schedules S1 and S2 respectively for a day.

FIG. 3C illustrates, in a graph, two boxes B1 and B2 formed for the two partial schedules PS1 and 152R by their upper and lower bounds on work duration on the y-axis (e.g. in units of hours) and by their upper and lower bounds on ending time of the work day on the x-axis (e.g. in units of time in a day).

FIGS. 4A-4F illustrate alternative sequences of activities of work which can be assigned to a schedule of an employee I within a specific period of time, namely between 8:00 am and 9:30 am.

FIG. 5 illustrates, in a low-level flow chart, acts performed by computer 1000 in a specific implementation.

FIGS. 6A and 6B illustrate, in block diagrams, hardware and software portions of a computer 1000 that performs the method illustrated in FIGS. 2 and 5.

### DETAILED DESCRIPTION

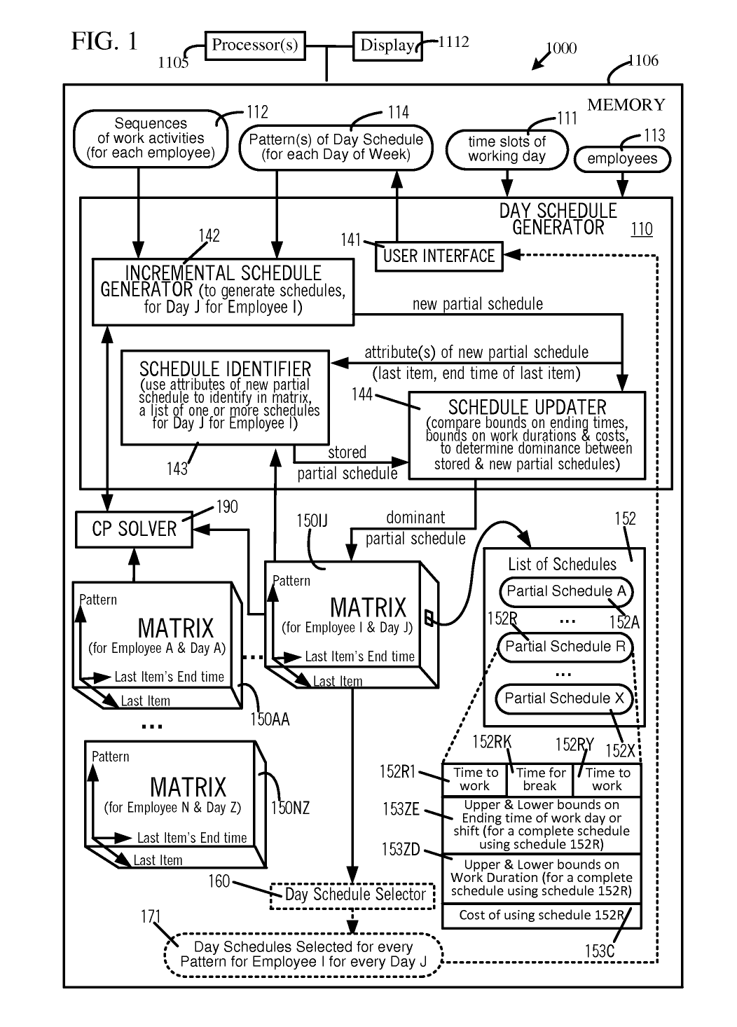

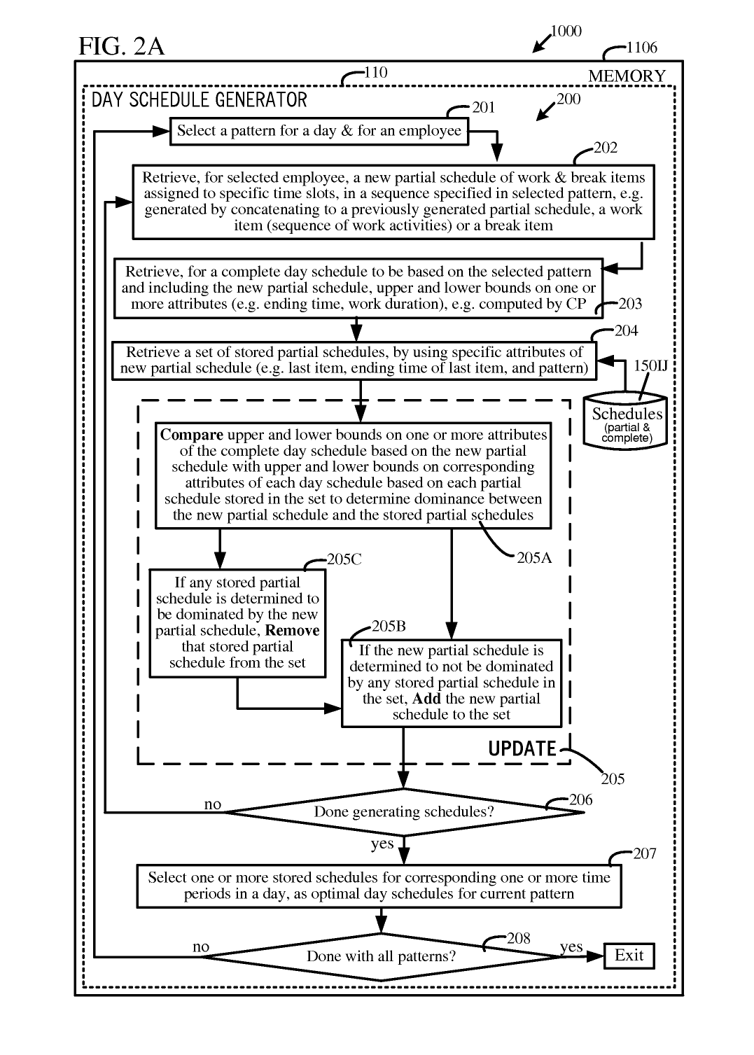

In several aspects of described embodiments, a computer 1000 (FIG. 1) is programmed with software (e.g. one or more sequences of instructions) in a memory 1106 that when executed by one or more processor(s) 1105 implements a day schedule generator 110. Day schedule generator 110 of some embodiments includes a user interface 141, a schedule generator 142, a schedule identifier 143 that is attribute specific, and a schedule updater 144 that determines dominance of one partial schedule by another partial schedule (e.g. by comparing bounds on an attribute of a complete schedule that is based on such a partial schedule). Day schedule generator 110 performs a set of acts 201-208 in a method 200 (FIG. 2A) to populate in a matrix 150U (FIG. 1), a number of partial schedules for an employee I in an organization, for various periods of time in a day J.

An item, which is assigned to time slots in a partial schedule 152R (FIG. 1) generated by day schedule generator 110 of certain embodiments, can be either of “type” work or of “type” break. An item of work (also referred to as an item of “type” work) may be assigned to a partial schedule 152R in one or more slots of time (i.e. time slots) 152R1 (FIG. 1), wherein an employee I is scheduled to work. Immediately following time slots 152R1, partial schedule 152R may have one or more time slots 152RK to which is assigned an item of break (also referred to as an item of “type” break) in which employee I is scheduled to do no work, such as time to eat lunch, or time for a coffee break, or time for rest. Time for an item of type break (regardless of whether for lunch or for coffee or for rest) is normally present between two time slots of two items of type work. Accordingly, time slots 152RK (see FIG. 1) in partial schedule 152R are followed by one or more time slots 152RY scheduled for work, when another item of “type” work is assigned (e.g. by adding time slots 152RY to a previously generated (and stored) partial schedule having time slots 152R1 and 152RK). To summarize, in some embodiments a schedule is built as a sequence of assignments of items to time slots in a day (in a shift), an item of work alternating with an item of break.

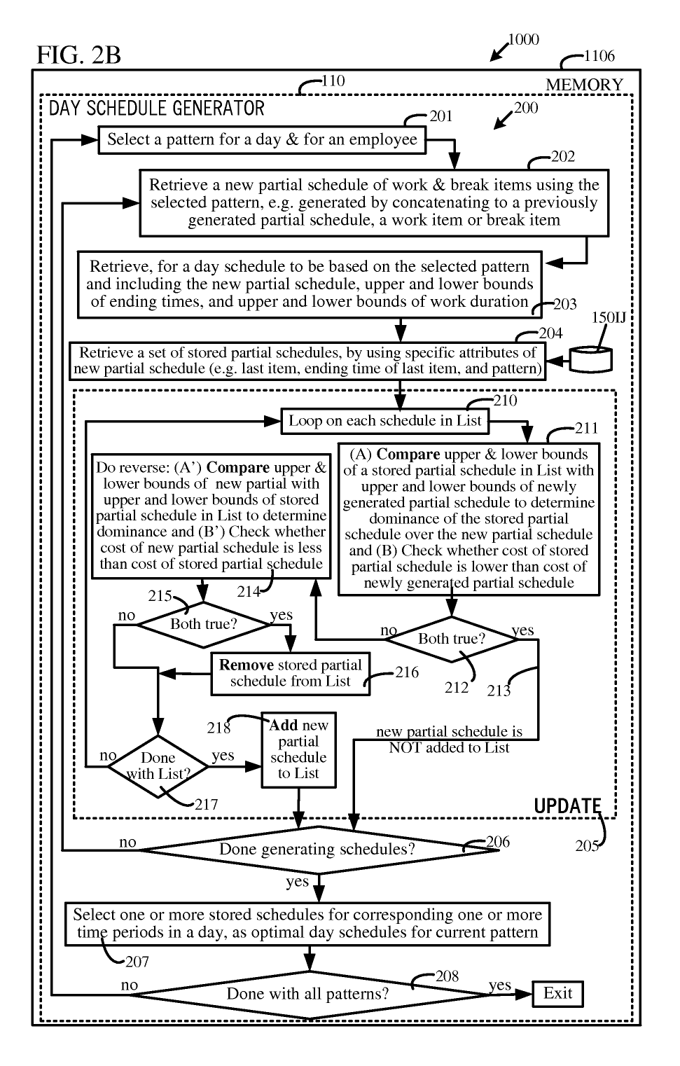

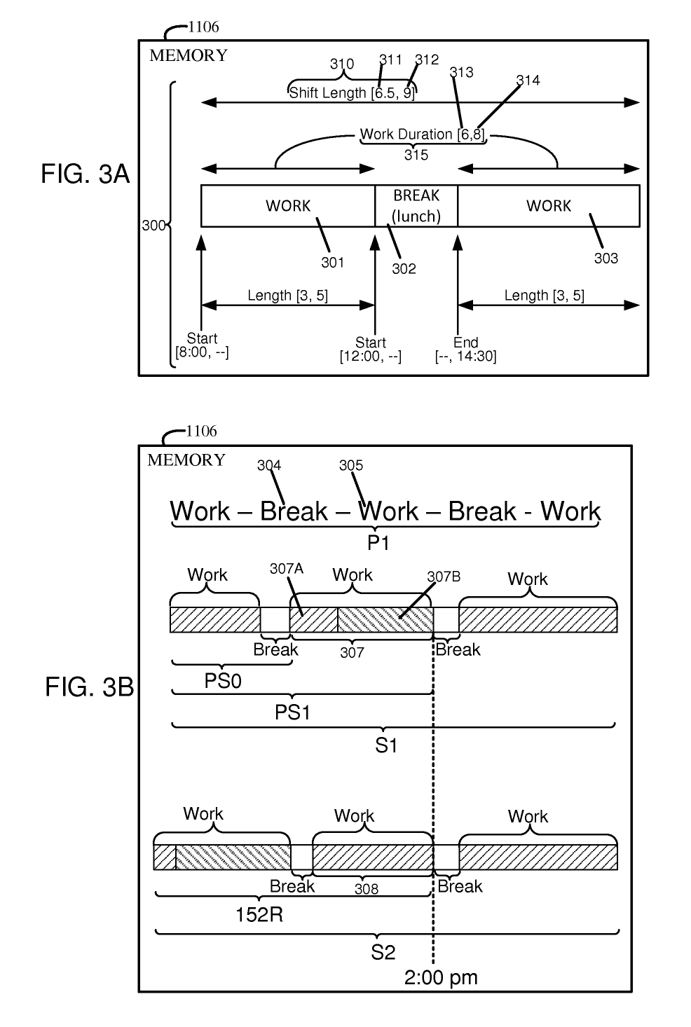

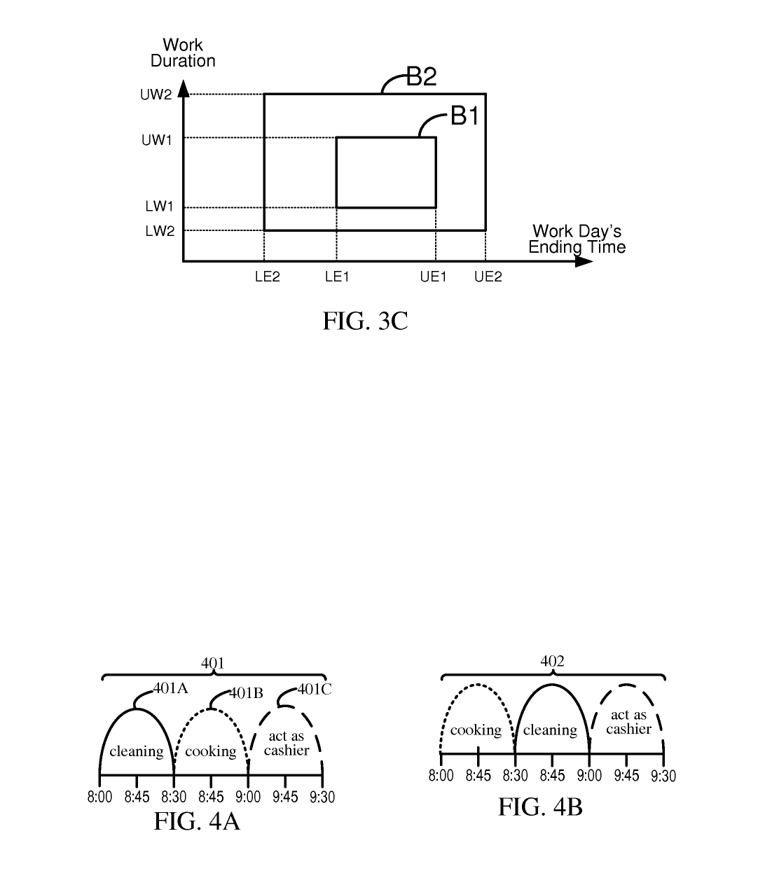

Computer 1000 (FIG. 1) may assign time slots 152R1, 152RK, 152RY (described in the previous paragraph, above) to a partial schedule based on a pattern of items (work or break), specified by employee I as input to user interface 141. For example, employee I may specify “Work-Break (for Lunch)-Work” as a succession of items, in a pattern 300 for a day J (e.g. Monday) as shown in FIG. 3A. An additional example of patterns (also called “day compositions”) is pattern P1 shown at the top of FIG. 3B as “Work-Break(for Lunch)-Work-Break(for Tea/Coffee)-Work”. In some embodiments, each item of a pattern has one or more bounds (e.g. upper bound, lower bound) on one or more properties of the item (also called “item properties”), e.g. lower and upper bounds on an item's start time, end time, and duration.

In addition to item properties for each item in a pattern, each pattern may have upper and lower bounds on one or more attributes of the pattern as a whole, such as ending time of work day (e.g. at which time the employee is scheduled to leave the organization's premises, also called shift ending time), and duration of work (e.g. hours during which time the employee is actually working). In an example illustrated in FIG. 3A, pattern 300 has a lower bound 311 on an attribute (also called “pattern attribute”), namely shift length 310 of 6.5 hours, and an upper bound 312 on this same attribute, namely shift length 310 of 9 hours. Shift length 310 provides to computer 1000 a constraint on an ending time of a complete schedule (which depends on a starting time of the complete schedule), e.g. if a complete schedule starts at 8 am, computer 1000 uses the just-described two shift lengths to determine (e.g. by use of CP solver 190), a lower bound on the shift's ending time to be 2:30 pm (e.g. by adding the lower bound of 6.5 hours to 8 am starting time) and an upper bound on the shift's ending time to be 5:00 pm (e.g. by adding the upper bound of 9 hours to the 8 am starting time), when there are no other constraints.

Moreover, as illustrated in FIG. 3A, pattern 300 has a lower bound 313 on another attribute, namely work duration 315 of 6 hours, an upper bound 314 on this same attribute, work duration 315 of 8 hours. In the above-described example for the complete schedule starting at 8 am, assume a partial schedule with 8 hours of work duration ends at 4:30 pm for example, in which case computer 1000 is programmed to determine the upper bound on ending time to be 4:30 pm, assuming no other constraints. As illustrated in FIG. 3A, a first item 301 in pattern 300 is an item of work with a lower bound on an item property namely length of 3 hours, an upper bound on this same item property, namely length of 5 hours. Also as illustrated in FIG. 3A, item 301 has a lower bound on an item property, namely starting time of 8:00 am, and an upper bound on this same item property, which is not specified (shown as “- -”).

Additionally, as illustrated in FIG. 3A, a second item 302 in pattern 300 is an item of break, hence time slots to which this item is assigned are scheduled for the employee to eat lunch. The second item 302 has a lower bound on an item property, namely starting time of 12:00 pm, and an upper bound on this item property that is not specified (shown as “- -”). The second item 302 has an upper bound on another item property, namely ending time of 14:30 pm, and a lower bound on this item property that is not specified (shown as “- -”). Finally, as illustrated in FIG. 3A, a third item 303 in pattern 300 is an item of work, which has a lower bound on the item's property, namely length of 3 hours, an upper bound on the same item property, namely length of 5 hours.

One or more patterns illustrated in FIG. 3A are used by some embodiments of computer 1000 to perform method 200 (FIG. 2A), as follows. Specifically, in an act 201 of method 200, a day schedule generator 110 in some embodiments of computer 1000 selects an employee I from among multiple employees A . . . I . . . N in a group of employees in the organization. Also in act 201 for employee I and for a current day J, day schedule generator 110 selects a pattern P from among one or more patterns 300, P1 (see pattern 300 in FIG. 3A and pattern P1 at the top of FIG. 3B) for the current day J. As noted above in reference to FIG. 3A, each pattern P may be specified as input to day schedule generator 110, by employee I, e.g. via user interface 141.

After selection of a current pattern P, day schedule generator 110 operates iteratively on selected pattern P, by selecting each item sequentially from left to right, as a current item. For a current item 305 (see top of FIG. 3B) in a selected pattern P, an incremental schedule generator 142 (FIG. 1) in day schedule generator 110 generates one or more partial schedules, unless the current item is the last item in the selected pattern P in which case the schedules generated are complete schedules. In some embodiments, incremental schedule generator 142 (FIG. 1) enumerates all possible schedules that end with a current item 305 in a selected pattern P and storing them in memory 1106 (at least temporarily, until retrieval in act 202).

To assist in enumeration, schedule identifier 143 in day schedule generator 110 may be configured to retrieve, from a matrix 150IJ, partial schedules generated previously that end with a previous item 304 of the selected pattern P (previous item 304 is located immediately before current item 305 in pattern P, as shown in FIG. 3A). Hence, incremental schedule generator 142 (FIG. 1) extends a previously generated (and stored) partial schedule PS0 (see FIG. 3B) multiple times by repeatedly assigning one or more time slots 307 using current item 305 (the newly assigned time slots being concatenated to previously assigned time slots), resulting in new partial schedules. In some embodiments, the minimum number of time slots 307 is two, and therefore two or more time slots are assigned when extending a previously generated partial schedule PS0 by use of current item 305. An example of a partial schedule PS1 shown in FIG. 3B is obtained in act 202 (FIG. 2A) by assigning current item 305 to time slots 307, to extend stored partial schedule PS0.

In assigning an item 305 of of type work to time slots 307 (FIG. 3B), one subset of time slots 307A may be assigned to one activity A of work (such as cleaning, in a bakery), and another subset of time slots 307B may be assigned to another activity B of work (such as cooking, in the bakery). The number of activities of work which are assigned to time slots 307 (e.g. 2 in number), and a specific sequence in which activities of work are assigned to time slots 307 (e.g. cleaning followed by cooking, or vice versa) can differ, depending on the embodiment. In assigning item 305 (FIG. 3B) of work to time slots 307, some embodiments may select a specific sequence of activities which is predetermined to be optimal among multiple possible sequences 112 (FIG. 1).

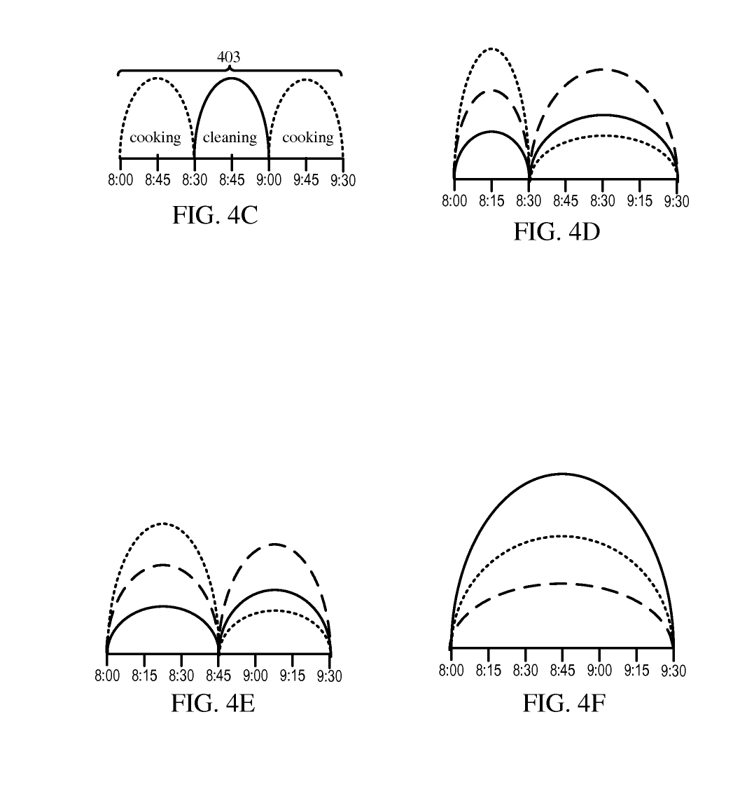

Numerous possible sequences 112 (FIG. 1) which can be performed by employee I in time slots 307 may be determined by enumerating different permutations of activities and comparing costs, as described briefly in the next two paragraphs below in reference to FIGS. 4A-4F and as further described in detail in U.S. application Ser. No. 13/934,148 entitled “GENERATING COST OPTIMIZED SEQUENCES OF ACTIVITIES, FOR MULTIPLE VALUES OF A SEQUENCE ATTRIBUTE, FOR NUMEROUS TIME PERIODS OF A DAY” filed concurrently herewith, by Nabil Guerinik et al. which is incorporated by reference herein in its entirety.

An example sequence 401 of three work activities which can be assigned when time slots 307 (FIG. 3B) occur between 8:00 am and 9:30 am is illustrated in FIG. 4A. Sequence 401 includes an activity of cleaning, to be scheduled in the first two time slots of 15 minutes duration in a work day (or shift) between 8:00 am and 8:30 am as shown by arc 401A, followed by another activity of cooking to be scheduled in the next two time slots between 8:30 am and 9:00 am as shown by arc 401B, followed by still another activity performed by a cashier (e.g. at a cash register) to be scheduled between 9:00 am and 9:30 am as shown by arc 401C. Sequence 401 is generated specifically for a given employee I. Hence, sequence 401 may be formed by use of information specific to the given employee, such as a time of day at which the given employee I begins work in the organization (and different employees may have different starting times). Depending on the embodiment, sequence 401 may be generated to satisfy one or more predetermined constraints, such as the employee's skills, employee's preferences, union rules on maximum duration of a work sequence, and/or duration between shifts.

Two alternative example sequences 402 and 403 which also include three activities of work are illustrated in FIGS. 4B and 4C. In addition to sequences of three activities illustrated in FIGS. 4A-4C, some embodiments also enumerate various permutations of two activity sequences, e.g. with a single transition at 8:30 as shown in FIG. 4D, and with a single transition at 8:45 as shown in FIG. 4E. Finally, some embodiments also enumerate single activity sequences as illustrated in FIG. 4F. Only one of the sequences of work activities illustrated in FIGS. 4A-4F is selected for assignment to time slots 307 (FIG. 3B), when item 305 of work is instantiated to extend a partial schedule PS0 in act 202. Thus, multiple sequences illustrated in FIGS. 4A-4F are received by day schedule generator 110, as input sequences 112 (FIG. 1).

In some embodiments, a sequence which is selected by day schedule generator 110 in act 202 for assignment to time slots 307 may be based on costs of activities. The costs of activities in specific time slots may be computed by computer 1000 in any manner that may be apparent to the skilled artisan in view of this detailed description. In some illustrative embodiments, costs are computed for assignments of activities of work as described in, for example, U.S. application Ser. No. 13/804,529 entitled “MODELING A GAP BETWEEN WORKLOAD AND NUMBER OF EMPLOYEES TO BE SCHEDULED BY CREATING AND USING NEW WORKLOAD LEVELS” filed on Mar. 14, 2013 by Nabil Guerinik et al. which is incorporated by reference herein in its entirety.

In repeatedly performing act 202 (FIG. 2A), to extend a partial schedule PS0 multiple times e.g. using different sequences of work activities, incremental schedule generator 142 (FIG. 1) may use one or more attributes of pattern P1 and/or one or more properties of current item 305, to determine a number of timeslots 307 to be included in partial schedule PS1. For example, current item 305 (FIG. 3) may have a length ranging between 2 hours and 3 hours, which is used to determine a number of time slots 307 to which the current item 305 can be validly assigned in partial schedule PS1. When the number of time slots 307 which may be included in partial schedule PS1 is valid within a range, the range is identified based on attributes and/or properties described above. Each valid number of time slots 307 is used by computer 1000 to enumerate and store in memory 1106 multiple partial schedules (including partial schedule PS1), for retrieval in act 202. Each of the just-described multiple partial schedules has a different number of time slots 307 and all of the just-described partial schedules are retrieved from memory 1106 in act 202 and processed by acts 203-204 and operation 205, in a manner similar to retrieval and processing of partial schedule PS1.

After extending a previously generated partial schedule PS0 to form a new partial schedule PS1, incremental schedule generator 142 (FIG. 1) determines and stores in memory 1106 one or more attributes of the new partial schedule PS1 for retrieval in act 203. For example, prior to performing act 203 to retrieve bounds, incremental schedule generator 142 (FIG. 1) determines and stores in memory 1106 the upper and lower bounds 153ZE (FIG. 1) of the ending time of the work day (or shift) of a complete schedule which includes new partial schedule PS1. Similarly, prior to performing act 203 to retrieve bounds, incremental schedule generator 142 also determines and stores in memory 1106 upper and lower bounds 153ZD (FIG. 1) of work duration in the complete schedule. The just-described bounds are computed in some embodiments by a CP solver 190, based on one or more partial schedules to be included in a to-be-generated complete schedule. Finally, prior to performing act 203, incremental schedule generator 142 also determines and stores in memory 1106 the cost 153C (FIG. 1) of including the partial schedule 152R in the complete schedule (e.g. as a sum of costs of sequences of work activities included therein).

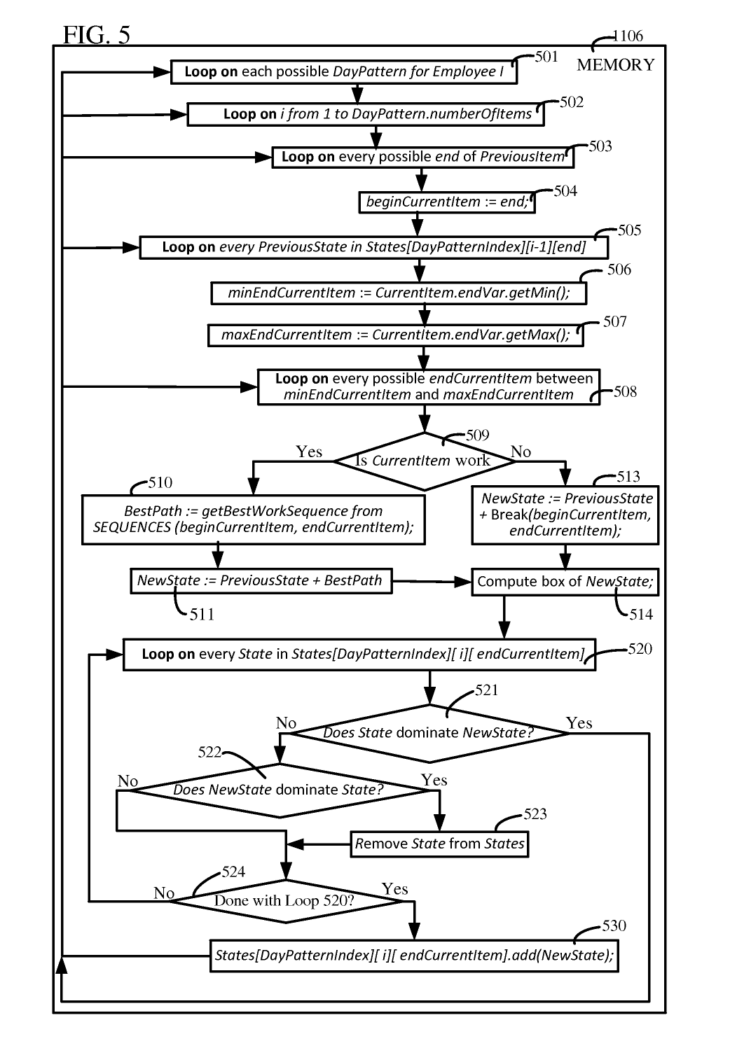

On completion of act 203 (FIG. 2A), upper and lower bounds 153ZE, upper and lower bounds 153ZD, and costs 153C are retrieved from memory 1106 with other such information on newly generated partial schedule 152R. Additionally, in act 204 a set of one or more schedules are retrieved, e.g. as a list 152 (or an array, depending on the embodiment). List 152 is identified in act 204 of some embodiments by a pointer (e.g. a memory address) in a cell of matrix 150U. In some embodiments, matrix 150U is a three dimensional matrix indexed by (1) an index which identifies a last item in partial schedule 152R, (2) the last item's ending time in partial schedule 152R, and (3) a pattern which is used to form partial schedule 152R. In some embodiments, items in a pattern are indexed starting from 1 (and increasing up to “numberOfItems”, as described below in reference to FIG. 5). In such embodiments, the first index described in the previous sentence ranges between 1 and numberOfItems.

Accordingly, each of partial schedules 152A, 152R and 152X in the list of schedules 152 has the same last item 152RY. Moreover in each of the three partial schedules 152A, 152R and 152X, their three respective last items 152RY all end at the same time (e.g. 12 noon). Finally, each of partial schedules 152A, 152R and 152X has been generated using the same current pattern P.

As noted above, matrix 1501J of some embodiments is a three dimensional matrix which may be looked up in an act 204 (FIG. 2A) by schedule identifier 143 (FIG. 1) using the last item 152RY as a first index, an ending time of the last item (e.g. 12 noon) as a second index, and the current pattern P as the third index. In several embodiments, matrix 150U does not store all possible partial schedules. Instead, a cell in matrix 1501J identifies a set of one or more partial schedules (e.g. stored in a list) which are not yet dominated by another partial schedule, for each pattern P used to prepare a partial schedule, for each index of last item in the partial schedule, and for each ending time slot (also called, “ending time”) of the last item (for each employee I, for each day J).

A lookup of matrix 150U is performed, in some embodiments, by a schedule identifier 143 which supplies a partial schedule from list 152 to incremental schedule generator 142 for extension thereof, to generate new partial schedule PS1. In addition, prior to retrieval in act 203 (FIG. 2A), incremental schedule generator 142 computes upper and lower bounds 153ZE (FIG. 1) for the ending time of the work day (or shift) of a to-be-generated complete schedule which is to include new partial schedule PS1 based on user input illustrated in FIG. 3A, such as lower bound 311 and upper bound 312 on length of 310 of work day, and lower bound 313 and upper bound 314 on work duration 315. Note that shift length 310 is the sum of durations of all items (of type work or break) in a schedule of a work day, and work duration 315 is the sum of durations of all items of type work in the schedule. Also in act 203, incremental schedule generator 142 computes upper and lower bounds 153ZD of work duration in the to-be-generated complete schedule.

The just-described upper and lower bounds 153ZE and 153ZD may be computed prior to retrieval in act 203 in any manner, e.g. by invoking a solver 190 (FIG. 1) to solve a constraint programming (CP) problem. Modeling a CP problem for a new partial schedule PS1 by use of attributes of a pattern as illustrated in FIG. 3A, and solving the CP problem to obtain upper and lower bounds 153ZE and 153ZD of a to-be-generated complete schedule by use of CP solver 190 is believed to be readily apparent to a skilled artisan, in view of this detailed description. Finally, also in act 203, incremental schedule generator 142 adds the cost of a sequence (see FIGS. 4A-4F) selected for assignment to time slots 307 (FIG. 3A) to a cost previously computed for partial schedule PS0, to obtain and store in memory 1106, the cost of newly generated partial schedule PS1.

For details on use of CP solver 190 prior to retrieval of attribute bounds in act 203, see, an article entitled “Constraint-Based Scheduling: A Tutorial” by Claude Le Pape, Sep. 11-15, 2005 at http://www.math.unipd.it/˜frossi/cp-school/lepape.pdf which is incorporated by reference herein in its entirety. In one illustrative embodiment, act 203 implements CP solver 190, similar or identical to Algorithm 2 entitled “CP based Column Generation Approach”, as described in an article entitled “A Constraint Programming based Column Generation Approach to Nurse Rostering Problems” by Fang He and Rong Qu, Computers and Operations Research, Volume 39 Issue 12, December, 2012, Pages 3331-3343, which is incorporated by reference herein in its entirety.

After retrieval of a new partial schedule in act 202, day schedule generator 110 uses the newly generated partial schedule PS1 to retrieve from memory 1106 one or more previously-generated partial schedules stored in matrix 150U, by performing act 204. Specifically, in act 204, a schedule identifier 143 in day schedule generator 110 retrieves, from a matrix 150U, partial schedules generated previously that meet the following three conditions: (1) have the same last item 305 as the newly generated partial schedule PS1, and (2) end at the same time as the newly generated partial schedule PS1, and (3) were generated using the same pattern P. Hence in act 204, the just-described three attributes are used as indexes into matrix 150U to retrieve a set of stored partial schedules, e.g. in the form of a list 152. Although a list is described herein, the set may be implemented as an array, or as a stack, or any other data structure apparent to the skilled artisan, in view of this description.

Thereafter, in operation 205 (FIG. 2A), a schedule updater 144 updates list 152 identified by a cell of matrix 150U by performing an operation 205A of comparison and depending on the result of comparison: an operation 205B of addition of the new partial schedule to list 152 and/or an operation 205C of removal of one or more stored partial schedules from list 152. In comparison operation 205A, schedule updater 144 compares the upper and lower bounds of one or more attributes of a complete day schedule to be generated based on the newly generated partial schedule PS1 with the upper and lower bounds on corresponding attributes of each day schedule to be generated based on each partial schedule stored in list 152. In operation 205B, schedule updater 144 adds the newly generated partial schedule PS1 to list 152 when the newly generated partial schedule PS1 is determined to be not dominated by any of the stored partial schedules in list 152. Moreover, in operation 205C schedule selector 144 removes from list 152 all stored partial schedules that are dominated by the newly generated partial schedule PS1.

The addition of newly generated partial schedule PS1 to list 152 is implemented by one or more processors programmed to perform operation 205B (which constitutes “means for adding” in some embodiments) in the normal manner of addition of any item to a list, e.g. by changing a forward pointer of a last item of list 152 to point to an address of PS1 in memory 1106, and by changing a backward pointer of PS1 to point to the last item of list 152 (which implement the means for adding in one embodiment). Similarly, removal of a stored partial schedule 152R from list 152 is implemented by one or more processors programmed to perform operation 205C (which constitutes “means for removing” in some embodiments) in the normal manner of removal of any item from a list, e.g. by changing a forward pointer of a previous item in list 152 to point to an address of a next item in memory 1106, and by changing a backward pointer of the next item to point to the previous item (which implement the means for removing in one embodiment).

In certain embodiments, one or more processors are programmed to use an array in memory 1106 to store a set of stored partial schedules (rather than a linked list), and the means for adding increments an array pointer to point, and copy PS1 into the array element identified by the incremented array pointer (which implement the means for adding in another embodiment). Similarly, removal of stored partial schedule 152R from the array is implemented in such embodiments by decrementing the array pointer (which implement another means for removing in another embodiment). In some embodiments, one or more processors are programmed to use a stack to store a set of stored partial schedules, the means for adding implements a push operation on the stack (which implement yet another means for adding in yet another embodiment). Similarly, removal of stored partial schedule 152R from the stack is implemented by one or more processors programmed to perform a pop operation on the stack (which implements yet another means for removing in yet another embodiment). Numerous “data” structures to implement a set of stored partial schedules will be apparent in view of this detailed description, as will be apparent software “algorithms” or “structures” to implement the “means for adding” a new partial schedule to a set, and to implement the “means for removing” a stored partial schedule from the set.

Update operation 205 of FIG. 2A (which constitutes “means for comparing” in some embodiments) may be implemented by one or more processors programmed to perform illustrative acts 210-218 shown in FIG. 2B. Thus acts 210-218 constitute a method for a computer 1000 to implement the means for comparing (and operations 205A-205C described above constitute another such method). Referring to FIG. 2B, schedule updater 144 loops on each schedule in the list identified in act 204, over the acts 211-217 as follows. In act 211, schedule selector 144 checks two conditions as follows: a first condition (A) determines whether a stored partial schedule 152R in list 152 dominates the new partial schedule PS1 by comparing respective bounds of one or more attributes of complete day schedules to be generated using these two partial schedules, and a second condition (B) determines whether the cost of the stored partial schedule 152R is lower than the cost of the new partial schedule PS1. Before checking the two conditions (A) and (B), a stored partial schedule 152R (in list 152) is selected in act 210 for use in comparison with a new partial schedule PS1, based on the following three conditions: (1) the same item (e.g. item 305) of pattern P1 is used to instantiate time slots 307 of partial schedule PS1 and time slots 308 of partial schedule 152R, (2) the ending time (e.g. time 2:00 pm) is the same for time slots 307 of partial schedule PS1 and for time slots 308 of partial schedule 152R, and (3) the same pattern P1 is used to generate partial schedule PS1 and partial schedule 152R.

In checking the first condition (A) described above, schedule selector 144 compares in act 211 (FIG. 2B) at least (1) upper and lower bounds on an attribute of a complete schedule S1 to be built using the new partial schedule PS1 with (2) upper and lower bounds on the attribute of another complete schedule S2 to be built using the stored partial schedule 152R. One illustrative attribute that may be used in the first condition (A) is the work duration (i.e. total hours of work) of complete schedules S1 and S2. Another illustrative attribute that may be used in the first condition (A) is the end of the work day, of complete schedules S1 and S2. The complete schedules S1 and S2 are not known at this stage, and instead their upper and lower bounds for one or more attributes are retrieved by one or more processors from memory 1106, e.g. after these bounds are determined using a CP solver 190 (FIG. 1).

Specifically, in some embodiments of the first condition (A), both attributes described in the previous paragraph are used in act 211 (FIG. 2B) as follows. Schedule selector 144 (implemented by one or more programmed processors) checks whether a “box” B2 (FIG. 3C) of complete schedule S2 formed by use of the upper and lower bounds of one attribute (e.g. ending time of work day or shift) on the x-axis, and by use of the upper and lower bounds of another attribute (e.g. work duration) on the y-axis contains a similar box B1 of complete schedule S1. In an example of the first condition (A), schedule selector 144 checks in act 211 (FIG. 2B) whether the lower bounds LW2 and LE2 of the respective attributes work duration and end ing time of work day for complete schedule S2 are less than or equal to the corresponding lower bounds LW1 and LE1 for complete schedule S1 (e.g. LW2≦LW1 and LE2≦LE1) and additionally whether the upper bounds UW2 and UE2 of the respective attributes work duration and ending time of work day for complete schedule S2 are greater than the corresponding upper bounds UW1 and UE1 for complete schedule S1 (e.g. UW2≧UW1 and UE2≧UE1).

The four checks between the bounds of the two attributes in first condition (A) as described in the preceding paragraph above, determine whether box B1 (FIG. 3C) is contained within (or enclosed in) box B2, i.e. whether partial schedule 152R dominates partial schedule PS1 in the two attributes (end of shift and work duration) on the x-axis and y-axis. Specifically, when all four conditions are met, box B1 is contained in box B2 (as shown in FIG. 3C) and hence new partial schedule PS1 is determined to be dominated by the stored partial schedule 152R. As will be apparent in view of this detailed description, other embodiments may use three attributes (along 3 axes) to determine dominance (requiring six comparisons) in other applications, or just one attribute (along one axis) to determine dominance in still other applications.

Comparisons of the type described above (e.g. LW2≦LW1, LE2≦LE1, UW2≦UW1 and UE2≦UE1) are performed in some embodiments by a digital comparator in an arithmetic logic unit (ALU) in a central processing unit (CPU) of a processor in a computer. Thus, means for comparing of some embodiments are implemented by one or more structures similar or identical to a binary comparator, such as TTL 7485 from Texas Instruments, or 74HC/HCT85 from Philips Semiconductors. Accordingly, a circuit to implement “means for comparing” the upper and lower bounds of one or more attributes will be apparent to a skilled artisan, in view of this description.

In checking the second condition (B) described above, the cost 153C of stored partial schedule 152R (which is retrieved from list 152) is compared in act 211 (FIG. 2B) with the cost of the new partial schedule PS1. When both conditions (A) and (B) are determined to be met in act 212 (FIG. 2B), the new partial schedule PS1 is determined to be dominated by one of the stored partial schedules of list 152, and hence schedule selector 144 exits the loop (started in act 210), and goes to act 206. In this way, the new partial schedule (which has been determined to be dominated) is not added to the list 152 identified by use of a cell in matrix 150U. In act 212 if the answer is no, schedule selector 144 goes to act 214.

In act 214 (FIG. 2B) schedule selector 144 checks the reverse dominance condition (A′), more precisely if box B1 contains box B2 (both boxes are described in the previous paragraph) and further checks the reverse cost condition (B′) if the cost 153C of stored partial schedule 152R (which is retrieved from list 152) is greater than the cost of the new partial schedule PS1. When both reverse conditions (A′) and (B′) are determined to be met in act 215 (FIG. 2B), the stored partial schedule 152R is determined to be dominated by the new partial schedule PS1 and hence schedule selector 144 removes the stored schedule 152R from list 152 in an act 216 and then goes to act 217. Schedule selector 144 also goes to act 217 when the answer is no in act 215. In act 217 schedule selector 144 checks if all partial schedules in list 152 have been processed and if not, schedule selector 144 returns to act 210 (described above). When all partial schedules in list 152 have been processed, schedule selector 144 goes to act 218 in which the new partial schedule PS1 is added to list 152, and then goes to act 206.

Thus, if the new partial schedule is not dominated by any stored partial schedule in list 152, then in act 218, schedule selector 144 adds the new partial schedule PS1 to list 152. Moreover, operation 216 removes from list 152 all stored partial schedules that are dominated by the newly generated partial schedule. Note that initially, when list 152 is empty, a new partial schedule is simply added to list 152. When any stored partial schedule in list 152 dominates the new partial schedule, schedule selector 144 discards the new partial schedule. In act 206, day schedule generator 110 checks if all schedules have been generated (e.g. by assignment of all items in the pattern P to time slots in the schedules identified by matrix 150U), and if not returns to act 202. As noted above act 202 may be implemented by an incremental schedule generator 142 that assigns items in pattern P to time slots.

When all items of pattern P (which was selected in act 201) are processed, the yes branch is taken in act 206 (described above), and on occurrence of this event a final set of optimal schedules for current pattern P remain stored in lists identified by the cells of matrix 150U. Such a final set of optimal schedules may be used in some embodiments, to perform act 207 e.g. by column generation for current pattern P, as will be apparent to the skilled artisan in view of this detailed description.

Accordingly, one or more day schedules for a current pattern P may be selected by day schedule generator 110 in an act 207 (FIG. 2A), followed by checking in an act 208, whether all patterns have been processed for employee I, and if not return to act 201 to select another pattern. In this manner, acts 201-207 may be performed by day schedule generator 110 for another pattern for the same day J. After all patterns for day J are processed for an employee Ito generate matrix 1501J, then acts 201-207 are again performed for one or more patterns in another day for the same employee, followed by repetition for different days for still another employee N. Hence, memory 1106 may store multiple matrices, such as matrix 150AA for employee A and day A, matrix 150IJ for employee I and day J, and matrix 150NZ for employee N and day Z.

Although a loop has been shown in FIG. 2A, from act 208 to 201 so that acts 202-207 may be performed by a single process in a single processor in computer 1000 to implement day schedule generator 110, in other embodiments the loop may be unrolled and the set of acts 202-207 may be performed by different processes in the single processor or by different processors in computer 1000. Moreover, although loop unrolling has just been described for a single loop between acts 202 and 208 of day schedule generator 110, such loop unrolling may be done for other loops illustrated in FIG. 2A (or illustrated in FIG. 5, which is described below).

In some embodiments, computer 1000 is programmed with instructions in memory 1106 to perform acts 501-514, 520-524 and 530 (illustrated in FIG. 5) for each employee I, as follows. In the following description, a “partial schedule” or a “complete schedule” is also referred to as a “state.” Initially computer 1000 creates a list of artificial states, and each state is initialized with an artificial item, which is added as a first item of every pattern (or day composition). Ending dates of these initial states correspond to all the possible values of the beginning of a day composition (or pattern). These states are initially empty, and they are used for their ending dates, for bootstrapping a method illustrated in FIG. 5. More precisely, the ending slots of the empty states are used by computer 1000 of some embodiments as possible starting dates for the states of a true first item of the day composition (or pattern).

Computer 1000 of some embodiments models a recursive process of building partial schedules starting from the beginning of the day like an enumerative tree whose nodes are valid states for any item. Such a model is maintained by a constraint programming solver that is used by computer 1000 of some embodiments. Therefore, if an unfeasibility occurs, computer 1000 handles backtracking on its own. Computer 1000 of certain embodiments searches for states that end in an item, by looking for states that end in each possible ending time slot of the item. This operation is also referred to herein as push of an item. When computer 1000 needs to push a current item, computer 1000 refers to its previous item, which is then used to start the push. Computer 1000 thus initializes the beginning time slot of a current item to an ending slot of the previous item. All possible pushing possibilities of a current item are explored by computer 1000 of some embodiments, before going to a next item in a day composition. In other terms, computer 1000 has all relevant states of a previous item when computer 1000 is trying to push the current item, which ensures correctness.

Accordingly, in an act 501 (FIG. 5), computer 1000 enters a first loop, for each possible value of a variable DayPattern, for each Employee I. After act 501, computer 1000 performs act 502 to enter a second loop, for each possible value of another variable i which denotes a current item ranging from 1 to numberOfItems in DayPattern. An example of the numberOfItems is 5 for pattern P1 shown at the top of FIG. 3B. After act 502, computer 1000 performs act 503 to enter a third loop, for each possible value of a variable end which identifies an ending time slot of a PreviousItem in the DayPattern (relative to current item therein, identified by variable i). After act 503, computer 1000 performs act 504 to initialize a variable beginCurrentItem to an ending time slot of the previous item. After act 504, computer 1000 performs act 505 to enter a fourth loop, for each possible value of a variable PreviousState in the matrix 150IJ stored in the array variable States and indexed as States[DayPatternIndex][i-1][end].

After act 505, computer 1000 performs acts 506 and 507 to respectively initialize two local variables minEndCurrentItem and maxEndCurrentItem based on corresponding Min and Max time slots in which CurrentItem can end (i.e. ending time). After act 507, computer 1000 performs act 508 to enter a fifth loop, for each possible value of a variable endCurrentItem identifying a time slot ranging between the two local variables minEndCurrentItem and maxEndCurrentItem. After act 508, computer 1000 performs act 509 to check whether CurrentItem is work, and if no goes to act 513. In act 513, computer 1000 extends PreviousState by adding an item of break between beginCurrentItem and endCurrentItem and this extended state is stored in variable NewState, followed by act 514.

In act 514, computer 1000 computes a box of NewState, e.g. computes upper and lower bounds of work duration and ending time of shift, as described above in reference to FIG. 3C. In act 509, if the answer is yes, computer 1000 performs act 510 wherein a sequence of activities BestPath is selected from among input sequences 112 (FIG. 1) stored in a matrix SEQUENCES indexed by timeslots beginCurrentItem and endCurrentItem. After act 510, computer 1000 performs act 511 to extend PreviousState by adding BestPath and this extended state is stored in variable NewState, followed by act 514 (described above).

After act 514, computer 1000 performs act 520 to enter a sixth loop, for each State in the array variable States indexed as States[DayPatternIndex][i][endCurrentItem]. After act 520, computer 1000 performs act 521 to check whether State dominates NewState and if yes breaks out of the sixth loop started by act 520, and returns to an earlier loop (e.g. any of acts 508, 505, 503, 502 or 501). If the answer in act 521 is no, computer 1000 goes to act 522 to check if the opposite is true, whether NewState dominates State and if yes goes to act 523. In act 523, computer 1000 removes the variable State from array variable States and goes to act 524. Computer 1000 also goes to act 524 if the answer in act 522 is no. In act 524, computer 1000 checks if the looping is completed (i.e. whether the condition in act 520 is met), and if not returns to act 520. In act 524, if computer 1000 finds that the looping is completed then computer 1000 goes to act 530. In act 530, computer 1000 stores the NewState in list 152 in matrix 150IJ and returns to an earlier loop (e.g. any of acts 508, 505, 503, 502 or 501).

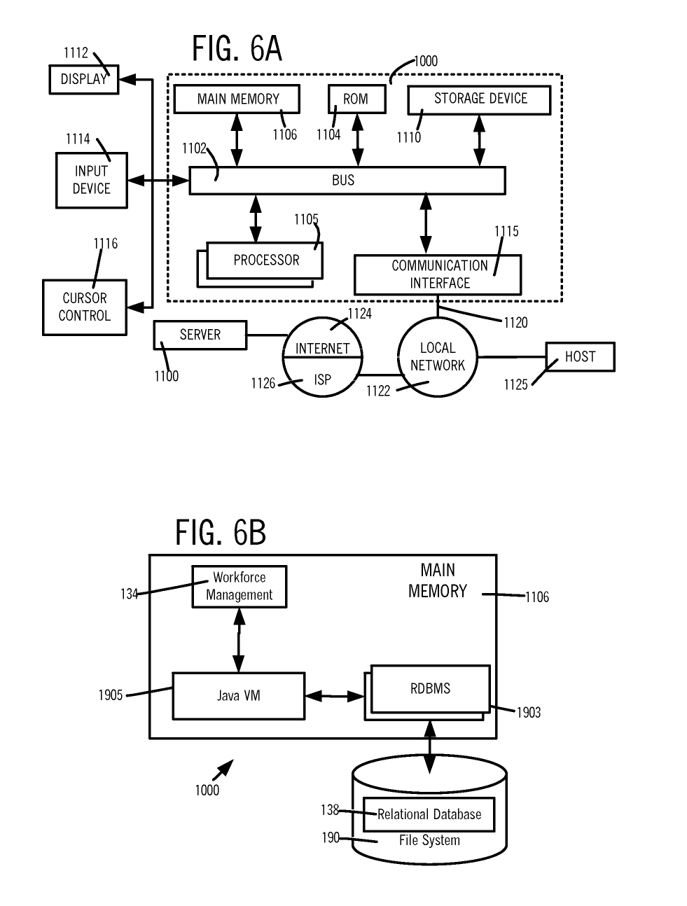

Several embodiments of the type described above are used by computer 1000 to solve a problem of building optimal weekly schedules for multiple employees belonging to the same organization, e.g. in workforce management software 134. One example of such software 134 (FIG. 6B) is commercially available as Oracle Workforce Scheduling, from Oracle Corporation, Redwood Shores, Calif. In some embodiments, one of the inputs to workforce management software 134 is the employees with their skills, their availabilities, and their rules (called also constraints), and another of the inputs is activities of work to be done in the organization with their respective demands. Accordingly, workforce management software 134 (FIG. 6B) includes the above-described day schedule generator 110 (FIG. 1).

Such a computer 1000 may be programmed in some embodiments to generate day schedules 171 (FIG. 1) that match as best as possible contributions of employees with the organization's workload while satisfying multiple constraints based on employee contracts and trade union rules, and satisfying also various business constraints. A schedule 171 provided as a result by computer 1000 of some embodiments performing one or more acts described herein is a detailed weekly schedule; detailed on the activities with a 15 minutes time step description. That means schedule 171 shows, for each 15 minutes slot of the week, which activity every employee is supposed to perform. Therefore, schedule 171 gives the work times, the break times and the detailed of covered activities.

In some embodiments, computer 1000 implements column generation based on Dantzig-Wolfe decomposition, which decomposes the set of constraints in two subsets. The overarching idea is that many linear programs are too large to consider all the variables explicitly. Since most of the variables are non-basic and assume a value of zero in the optimal solution, only a subset of variables need to be considered when solving the employee scheduling problem. The column generation approach used in computer 1000 of some embodiments initializes a linear program (LP) with a subset of columns. The method consists then to generate, within an iterative algorithm, the variables which have the potential to improve the objective function, i.e. to find variables with negative reduced cost (assuming without loss of generality that the problem is a minimization problem). These variables are added to populate a linear program. The name “column generation” is used in computer 1000 of certain embodiments wherein a variable represents a column of the LP.

A column generation process used in computer 1000 of some embodiments decomposes the employee scheduling problem being solved into two problems: a master problem and one or more slave problems. Thus, in computer 1000 of several embodiments, a master problem is an original problem of employee scheduling with only a subset of variables being considered (and hence a subset of constraints). The slave problem in computer 1000 of several embodiments is a new problem created to identify new improving variables to be added to the master problem. The objective function of the slave problem in computer 1000 of certain embodiments is reduced cost of the new variable with respect to the current values of the dual variables. The constraints of an initial model of employee scheduling in computer 1000 of some embodiments that are not part of the master problem are respected in the slave problem. The column generation process used in computer 1000 terminates when no negative reduced cost variable can be generated by the slave problem. Accordingly, computer 1000 of several embodiments relies on the fact that the linear program (LP) obtained at the end is smaller than the initial linear program (LP) of the problem with all its variables being explicitly generated.

In modeling the employee scheduling problem, computer 1000 of certain embodiments associates a binary variable with every possible daily schedule of an employee (denoted by Scheduleₑ). Hence, the columns of the linear program modeling in computer 1000 of some embodiments are the daily schedules. Since the number of such schedules is huge, the use of column generation is more than appropriate in order to generate only the good ones, to be kept in the final linear program. In other words, the employee scheduling problem is decomposed by computer 1000 of certain embodiments into a single master problem and several slave problems. Each slave problem is located by computer 1000 of certain embodiments in a window (one employee, one day) and contains only the constraints of that employee on that day.

The master problem in a computer 1000 of several embodiments contains the weekly constraints, the workload constraints (over several employees) and the main objective function (to minimize). All the constraints of the master problem in computer 1000 of some embodiments are linear. The column generation process in computer 1000 of several embodiments maintains a permanent communication between a window of the master problem and windows of the slave problems.

The master problem is solved in some embodiments of computer 1000 by use of a simplex algorithm which gives as a result the optimal dual values: kind of indicators given to the slaves to guide their self-optimization on the local window (person, day). An illustrative implementation of the simplex algorithm by computer 1000 may invoke a linear solver known as ILOG CPLEX, available from IBM Corporation.

Thus, computer 1000 of several embodiments provides new schedules to its master window, corresponding to a local window (person, day) of the slave, with each new schedule having the potential to decrease the value of the objective function. The master linear program (LP) formulated by computer 1000 of some embodiments initially contains no schedule, hence no column. A day schedule 171 (FIG. 1) is iteratively populated by the daily schedules built by local windows of slave problems until no negative reduced cost schedule can be generated.

When the column generation algorithm is finished, employee scheduling problem is not solved in computer 1000 of several embodiments, since we have got an optimal continuous solution and not a mixed integer one. A final step consists in computer 1000 of several embodiments launching a MIP solver on the final master LP in order to select the optimal schedules (those corresponding to the variables Schedule, with a value 1 in the solution).

The method of FIG. 2A or FIG. 2B may be used to program one or more computer(s) 1000, each of which may be implemented as illustrated in FIG. 6A which is discussed next. Specifically, computer 1000 includes a bus 1102 (FIG. 6A) or other communication mechanism for communicating information, and one or more processor(s) 1105 coupled with bus 1102 for processing information. Computer 1000 uses (as the above-described memory) a main memory 1106, such as a random access memory (RAM) or other dynamic storage device, coupled to bus 1102 for storing information and instructions (e.g. to perform the acts of FIG. 2A or FIG. 2B) to be executed by processor 1105.

Main memory 1106 also may be used for storing temporary variables or other intermediate information during execution of instructions to be executed by processor 1105. Computer 1000 further includes a read only memory (ROM) 1104 or other static storage device coupled to bus 1102 for storing static information and instructions for processor 1105, such as software in the form of model generator 440. A storage device 1110, such as a magnetic disk or optical disk, is provided and coupled to bus 1102 for storing information and instructions.

Computer 1000 may be coupled via bus 1102 to a display device or video monitor 1112 such as a cathode ray tube (CRT) or a liquid crystal display (LCD), for displaying information to a computer user (e.g. a store manager) may be displayed on display 1112. An input device 1114, including alphanumeric and other keys (e.g. of a keyboard), is coupled to bus 1102 for communicating information (such as user input) to processor 1105 (e.g. executing user interface 141 of FIG. 1). Another type of user input device is cursor control 1116, such as a mouse, a trackball, or cursor direction keys for communicating information and command selections to processor 1105 and for controlling cursor movement on display 1112. This input device typically has two degrees of freedom in two axes, a first axis (e.g., x) and a second axis (e.g., y), that allows the device to specify positions in a plane. In addition to display device 1112, computer 1000 may include a speaker (not shown) as another output device for use by processor 1105 (e.g. executing user interface 141 of FIG. 1).

As described elsewhere herein, workforce management is implemented by computer 1000 in response to processor 1105 executing one or more sequences of one or more instructions that are contained in main memory 1106. Such instructions may be read into main memory 1106 from another non-transitory computer-readable storage medium, such as storage device 1110. Execution of the sequences of instructions contained in main memory 1106 causes processor 1105 to perform the operations of a process described herein and illustrated in FIG. 2A or FIG. 2B. In alternative embodiments, hard-wired circuitry may be used in place of or in combination with software instructions.

The term “non-transitory computer-readable storage medium” as used herein refers to any non-transitory storage medium that participates in providing instructions to processor 1105 for execution. Such a non-transitory storage medium may take many forms, including but not limited to (1) non-volatile storage media, and (2) volatile storage media. Common forms of non-volatile storage media include, for example, a floppy disk, a flexible disk, hard disk, optical disk, magnetic disk, magnetic tape, or any other magnetic medium, a CD-ROM, any other optical medium, punch cards, paper tape, any other physical medium with patterns of holes, a PROM, and EPROM, a FLASH-EPROM, any other memory chip or cartridge that can be used as storage device 1110, to store program code in the form of instructions and/or data structures and that can be accessed by computer 1000. Volatile storage media includes dynamic memory, such as main memory 1106 which may be implemented in the form of a random access memory or RAM.

Instructions to processor 1105 can be provided by a transmission link or by a non-transitory storage medium from which a computer can read information, such as data and/or code. Specifically, various forms of transmission link and/or non-transitory storage medium may be involved in providing one or more sequences of one or more instructions to processor 1105 for execution. For example, the instructions may initially be comprised in a non-transitory storage device, such as a magnetic disk, of a remote computer. The remote computer can load the instructions into its dynamic memory (RAM) and send the instructions over a telephone line using a modem.

A modem local to computer 1000 can receive information about a change to a collaboration object on the telephone line and use an infra-red transmitter to transmit the information in an infra-red signal. An infra-red detector can receive the information carried in the infra-red signal and appropriate circuitry can place the information on bus 1102. Bus 1102 carries the information to main memory 1106, from which processor 1105 retrieves and executes the instructions. The instructions received by main memory 1106 may optionally be stored on storage device 1110 either before or after execution by processor 1105.

Computer 1000 also includes a communication interface 1115 coupled to bus 1102. Communication interface 1115 provides a two-way data communication coupling to a network link 1120 that is connected to a local network 1122. Local network 1122 may interconnect multiple computers (as described above). For example, communication interface 1115 may be an integrated services digital network (ISDN) card or a modem to provide a data communication connection to a corresponding type of telephone line. As another example, communication interface 1115 may be a local area network (LAN) card to provide a data communication connection to a compatible LAN. Wireless links may also be implemented. In any such implementation, communication interface 1115 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1125 or to data equipment operated by an Internet Service Provider (ISP) 1126. ISP 1126 in turn provides data communication services through the world wide packet data communication network 1124 now commonly referred to as the “Internet”. Local network 1122 and network 1124 both use electrical, electromagnetic or optical signals that carry digital data streams. The signals through the various networks and the signals on network link 1120 and through communication interface 1115, which carry the digital data to and from computer 1000, are exemplary forms of carrier waves transporting the information.

Computer 1000 can send messages and receive data, including program code, through the network(s), network link 1120 and communication interface 1115. In the Internet example, a server 1100 might transmit information retrieved from RDBMS database through Internet 1124, ISP 1126, local network 1122 and communication interface 1115. The instructions for performing the operations or acts of FIG. 2A or FIG. 2B may be executed by processor 1105 as they are received, and/or stored in storage device 1110, or other non-volatile storage for later execution. In this manner, computer 300 may additionally or alternatively obtain instructions and any related data in the form of a carrier wave.

Note that FIG. 6A is a very low-level representation of many hardware components of a computer system. Several embodiments have one or more additional software components in main memory 1106 as shown in FIG. 6B. In addition to main memory 1106, computer 1000 may include one or more other types of memory such as flash memory (or SD card) and/or a hard disk and/or an optical disk (also called “secondary memory”) to store data and/or software for loading into memory 1106 (also called “main memory”) and/or for use by processor(s) 1105. In some embodiments, computer 1000 of FIG. 6A implements a relational database management system 1905 to manage data in one or more tables of a relational database 1903 of the type illustrated in FIG. 6B. Such a relational database management system 1903 may manage a distributed database system that includes multiple databases, each table being stored on different storage mechanisms.

In some embodiments, the multiple databases are made to appear as a single database. In such embodiments, processor 1105 can access and modify the data in a relational database 138 via RDBMS 1903 that accepts queries in conformance with a relational database language, the most common of which is the Structured Query Language (SQL). The commands are used by processor 1105 of some embodiments to store, modify and retrieve data about an application program in the form of rows in a table in relational database 138. Relational database management system 1903 further includes output logic that makes the data in a database table available to a user via a graphical user interface that generates a screen on a video monitor display 1112. In one example, the output logic of computer 1000 provides results via a web-based user interface that depicts in a browser, information related to schedules of activity assignments as illustrated in FIG. 1. Additionally and/or alternatively, screens responsive to a command in a command-line interface and display on a video monitor may be generated in a user interface 141 (such as a GUI of the type described above in reference to FIG. 1).

In some embodiments of computer 1000, functionality in the above-described day schedule generator 110 is implemented by processor 1105 executing software in memory 1106 of computer 1000, although in other embodiments such functionality is implemented in any combination of hardware circuitry and/or firmware and/or software in computer 1000. Depending on the embodiment, various functions of the type described herein may be implemented in software (executed by one or more processors or processor cores) or in dedicated hardware circuitry or in firmware, or in any combination thereof. Accordingly, depending on the embodiment, any one or more of day schedule generator 110 can, but need not necessarily include, one or more microprocessors, embedded processors, controllers, application specific integrated circuits (ASICs), digital signal processors (DSPs), multi-core processors and the like.

Any non-transitory computer readable medium tangibly embodying software (also called “computer instructions”) may be used in implementing one or more acts or operations described herein and illustrated in FIG. 2A or FIG. 2B. Such software may include program codes stored in memory 1106 and executed by processor 1105. Memory 1106 may be implemented within or external to processor 1105, depending on the embodiment. When implemented in firmware and/or software, logic to perform one or more acts or operations of FIG. 2A or FIG. 2B may be stored as one or more computer instructions or code on a non-transitory computer-readable medium. Examples include non-transitory computer-readable storage media encoded with a data structure such as a matrix 150U that holds partial schedules and/or complete schedules (FIG. 1) and non-transitory computer-readable storage media encoded with a computer program to be executed by one or more processors to implement day schedule generator 110.

In some embodiments, a computer 1000 may include multiple processors, each of which is programmed with software in a memory 1106 shared with each other to perform acts of the type described above to store partial schedules in a matrix 1501J. For example, a first processor 1105 in computer 1000 may be programmed with software to retrieve from memory 1106 a new partial schedule including a sequence of assignments of items (with at least one item of work). A second processor 1105 in computer 1000 may be programmed with software to use at least a type of a last item assigned in the sequence and an ending time of the last item to identify and retrieve from memory 1106, a set of one or more stored partial schedules. A third processor 1105 in computer 1000 may be programmed with software to implement means for comparing at least: (A) upper and lower bounds on an attribute of a first complete schedule to be built using the new partial schedule with (B) upper and lower bounds on said attribute of a second complete schedule to be built using a stored partial schedule in the set, to determine dominance between the new partial schedule and the stored partial schedule. A fourth processor 1105 in computer 1000 may be programmed with software to implement means for adding the new partial schedule to the set in memory 1106, when the new partial schedule is determined to be not dominated by any stored partial schedule. A fifth processor 1105 in computer 1000 may be programmed with software to implement means for removing a stored partial schedule from the set in memory 1106, when the stored partial schedule is determined to be dominated by the new partial schedule.

Although five processors 1105 have been just described for some embodiments to implement the respective means, in other embodiments a single processor 1105 may be used in a time shared manner to implement the just-described means of the previous paragraph. Furthermore, in still other embodiments, one processor 1105 may be used in a time-shared manner to implement one or more parts of the means for retrieving, one or more parts of the means for comparing and one or more parts of the means for adding and one or more parts of the means for removing. Moreover, one or more other processors 1105 may be also used in a time-shared manner to implement other parts of the means for generating, other parts of the means for retrieving, other parts of the means for comparing, other parts of the means for adding and other parts of the means for removing. Furthermore, although processors 1105 have been described above for certain embodiments as being included in a single computer 1000, in other embodiments multiple such processors 1105 may be included in multiple computers 1000, for example a first computer 1000 may implement the means for retrieving, the means for comparing and the means for adding and the means for removing.

In one or more such embodiments, one or more processor(s) 1105 with a bus 1103 implement means for adding a new partial schedule to the set in memory 1106 and means for removing a stored partial schedule from the set in memory 1106. One or more such processors 1105 may also implement other functionality, such as day schedule generator 110 that generates partial schedules in a list identified by a cell in matrix 1501J (FIG. 1). One or more such processors 1105 may further implement additional functionality in day schedule generator 110, such as a user interface 141 (FIG. 1) that generates screens on display 1112 through which a user may view (and use a keyboard and/or mouse to edit) data in memory 1106, such as time slots on a working day 111, employees and skills 113, employee schedules 171, patterns 114 and sequences 112. The partial schedules in matrix 150U may be stored in a database 138 (FIG. 6B) which may additionally store selected day schedules indicative of each time slot in a day (e.g. identified by start time & duration) and a specific activity which is to be performed by a specific employee in a specific time slot.

Numerous modifications and adaptations of the embodiments described herein will become apparent to the skilled artisan in view of this disclosure. Numerous modifications and adaptations of the embodiments described herein are encompassed by the attached claims.

1. A computer-implemented method to prepare schedules for employees in an organization, the computer-implemented method comprising:
retrieving from one or more computer memories, a new partial schedule for an employee in the organization, the new partial schedule comprising a sequence of time slots to which are assigned multiple items including an item of work;
retrieving from the one or more computer memories, a set of one or more stored partial schedules, the set being identified at least partially by (1) an index of a last item assigned in the sequence, and (2) an ending time of the last item;
comparing at least: (A) a first upper bound and a first lower bound on an attribute of a first complete schedule to be built including the new partial schedule with (B) a second upper bound and a second lower bound on said attribute of each second complete schedule to be built using each stored partial schedule in the set, to at least partially determine dominance between the new partial schedule and the stored partial schedules in the set;
adding the new partial schedule to the set, when the new partial schedule is determined to not be dominated by any stored partial schedule in the set; and
removing a stored partial schedule from the set, when the stored partial schedule is determined to be dominated by the new partial schedule;
wherein at least the comparing, the adding, and the removing, are performed by one or more processors coupled to the one or more computer memories.

2. The computer-implemented method of claim 1 wherein:
the attribute is work duration.

3. The computer-implemented method of claim 1 wherein:
the attribute is ending time.

4. The computer-implemented method of claim 1 wherein:
the attribute is hereinafter a first attribute;
the complete schedule has a second attribute; and
the computer-implemented method further comprises comparing (C) a third upper bound and a third lower bound on the second attribute of the first complete schedule with (D) a fourth upper bound and a fourth lower bound on said second attribute of the second complete schedule.

5. The method of claim 4 wherein:
the stored partial schedule is dominated by the new partial schedule when
the first upper bound is larger than the second upper bound;
the first lower bound is smaller than the second lower bound;
the third upper bound is larger than the fourth upper bound; and
the third lower bound is smaller than the fourth lower bound.

6. The method of claim 1 wherein:
the new partial schedule comprises a new item immediately following the last item of another stored partial schedule; and
the new item is of a type different from the last item.

7. The method of claim 1 wherein:
the multiple items assigned to time slots in the new partial schedule conform to a pattern; and
each stored partial schedule in the set comprises time slots to which are assigned said multiple items in conformance with said pattern.

8. The method of claim 7 wherein:
the set is identified by a cell in a three dimensional matrix stored in the one or more computer memories; and
the three dimensional matrix is indexed by:
(A) the index of the last item;
(B) the ending time of the last item; and
(C) an identifier of the pattern.

9. The method of claim 7 wherein:
at least the comparing, the adding, and the removing, are performed numerous times for said pattern, and several times for additional patterns.

10. One or more non-transitory computer-readable storage media comprising a plurality of instructions executable by one or more processors in a computer, the plurality of instructions comprising:
instructions to retrieve from one or more computer memories, a new partial schedule for an employee in an organization, the new partial schedule comprising a sequence of time slots to which are assigned multiple items including an item of work;
instructions to retrieve from the one or more computer memories, a set of one or more stored partial schedules, the set being identified at least partially by (1) an index of a last item assigned in the sequence, and (2) an ending time of the last item;
instructions to compare at least: (A) upper and lower bounds on an attribute of a first complete schedule to be built including the new partial schedule with (B) respective upper and lower bounds on said attribute of each second complete schedule to be built using each stored partial schedule in the set, to determine dominance between the new partial schedule and the stored partial schedules in the set;
instructions to add the new partial schedule to the set, when the new partial schedule is determined to not be dominated by any stored partial schedule in the set; and
instructions to remove a stored partial schedule from the set, when the stored partial schedule is determined to be dominated by the new partial schedule;
wherein at least the instructions to compare, the instructions to add, and the instructions to remove, are to one or more processors coupled to the one or more computer memories.

11. The one or more non-transitory computer-readable storage media of claim 10 wherein:
the attribute is work duration.

12. The one or more non-transitory computer-readable storage media of claim 10 wherein:
the attribute is ending time.

13. The one or more non-transitory computer-readable storage media of claim 10 wherein:
the attribute is hereinafter a first attribute;
the complete schedule has a second attribute; and
the computer-implemented method further comprises comparing (C) a third upper bound and a third lower bound on the second attribute of the first complete schedule with (D) a fourth upper bound and a fourth lower bound on said second attribute of the second complete schedule.

14. The one or more non-transitory computer-readable storage media of claim 13 wherein:
the stored partial schedule is dominated by the new partial schedule when
the first upper bound is larger than the second upper bound;
the first lower bound is smaller than the second lower bound;
the third upper bound is larger than the fourth upper bound; and
the third lower bound is smaller than the fourth lower bound.

15. The one or more non-transitory computer-readable storage media of claim 10 wherein:
the new partial schedule comprises a new item immediately following the last item of another stored partial schedule; and
the new item is of a type different from the last item.

16. The one or more non-transitory computer-readable storage media of claim 10 wherein:
the multiple items assigned to time slots in the new partial schedule conform to a pattern; and
each stored partial schedule in the set comprises time slots to which are assigned said multiple items in conformance with said pattern.

17. The one or more non-transitory computer-readable storage media of claim 16 wherein:
the set is identified by a cell in a three dimensional matrix stored in the one or more computer memories; and
the three dimensional matrix is indexed by:
(A) the index of the last item;
(B) the ending time of the last item; and
(C) an identifier of the pattern.

18. The one or more non-transitory computer-readable storage media of claim 10 wherein:
at least the instructions to compare, the instructions to add, and the instructions to remove, are configured for execution numerous times for said pattern, and several times for additional patterns.

19. An apparatus comprising:
one or more computer memories coupled to one or more processors;
wherein the one or more computer memories comprise a new partial schedule for an employee in an organization, the new partial schedule comprising a sequence of time slots to which are assigned multiple items including an item of work;
wherein the one or more computer memories further comprise a set of one or more stored partial schedules, the set being identified at least partially by (1) an index of a last item assigned in the sequence, and (2) an ending time of the last item;
means for comparing at least: (A) upper and lower bounds on an attribute of a first complete schedule to be built including the new partial schedule with (B) respective upper and lower bounds on said attribute of each second complete schedule to be built using each stored partial schedule in the set, to determine dominance between the new partial schedule and the stored partial schedules in the set;
means for adding the new partial schedule to the set, when the new partial schedule is determined to not be dominated by any stored partial schedule in the set; and
means for removing a stored partial schedule from the set, when the stored partial schedule is determined to be dominated by the new partial schedule;
wherein at least the instructions to compare, the instructions to add, and the instructions to remove, are to one or more processors coupled to the one or more computer memories.

20. The apparatus of claim 19 wherein:
the attribute is hereinafter a first attribute;
the complete schedule has a second attribute; and
the apparatus further comprises means for comparing (C) a third upper bound and a third lower bound on the second attribute of the first complete schedule with (D) a fourth upper bound and a fourth lower bound on said second attribute of the second complete schedule.
